(19) United States
(12) Patent Application Publication
(10) Pub. No.: US 2026/0348842 A1
(43) Pub. Date: Nov. 5, 2026

(54) SUBSTRATE INSPECTION APPARATUS AND FLOW RATE CONTROL DEVICE AND METHOD FOR INSPECTING SUBSTRATE

(71) Applicant: SAMSUNG ELECTRONICS CO., LTD., Suwon-si (KR)

(72) Inventors: Pyoung Sik SHIN, Suwon-si (KR); Sun Hong JUN, Suwon-si (KR); Young Hoon SOHN, Suwon-si (KR); Han Jung RYU, Suwon-si (KR)

(73) Assignee: SAMSUNG ELECTRONICS CO., LTD., Suwon-si (KR)

(21) Appl. No.: 19/416,253

(22) Filed: Dec. 11, 2025

(30) Foreign Application Priority Data
Apr. 30, 2025 (KR) 10-2025-0057411

(51) Int. Cl. G01N 21/31; G01N 21/3563

(52) U.S. Cl. CPC G01N 21/314; G01N 21/3563; G01N 2021/3155; G01N 2021/3568

(57) ABSTRACT

Provided is a substrate inspection apparatus including a signal detector configured to emit a first pulse having a first wavelength band and a second pulse having a second wavelength band to a substrate and output an interface signal, and a signal analyzer configured to generate a reference signal based on the second pulse, and generate a heterodyne signal formed by interference between the reference signal and the interface signal, wherein an amplitude of the interface signal and phase information of the interface signal are restored based on the heterodyne signal.

### CROSS-REFERENCE TO RELATED APPLICATION

This application claims priority from Korean Patent Application No. 10-2025-0057411 filed on Apr. 30, 2025 in the Korean Intellectual Property Office, the disclosure of which is incorporated herein in its entirety by reference.

### BACKGROUND

### FIELD

Embodiments of the present disclosure relate to a substrate inspection apparatus and a method for inspecting a substrate.

### DESCRIPTION OF RELATED ART

Obtaining interface characteristics of semiconductor process intermediate elements, which have a significant effect on a speed and a defect rate of an etching process or the like may be needed in advance. One of the factors that affect the electrical characteristics of the element interface may be the concentration of some ions doped into the silicon substrate. Therefore, in order to more accurately ensure the doping concentration of ions for a specific interface, it may be required to enable correction for height in real time.

### SUMMARY

One or more embodiments provide a substrate inspection apparatus having improved accuracy.

One or more embodiments also provide a method for inspecting a substrate having improved accuracy.

According to an aspect of one or more embodiments, there is provided a substrate inspection apparatus including a signal detector configured to emit a first pulse having a first wavelength band and a second pulse having a second wavelength band to a substrate and output an interface signal, and a signal analyzer configured to generate a reference signal based on the second pulse, and generate a heterodyne signal formed by interference between the reference signal and the interface signal, wherein an amplitude of the interface signal and phase information of the interface signal are restored based on the heterodyne signal.

According to an aspect of one or more embodiments, there is provided a method for inspecting a substrate including outputting a femtosecond pulse by a light source, separating the femtosecond pulse into a first pulse having a first wavelength band and a second pulse having a second wavelength band by a beam splitter, emitting the first pulse and the second pulse to a wafer and outputting an interface signal, generating a reference signal based on the second pulse, generating a heterodyne signal formed by interference between the reference signal and the interface signal, and restoring an amplitude and phase information of the interface signal based on the heterodyne signal.

According to still another aspect of one or more embodiments, there is provided a substrate inspection apparatus including a signal detector configured to emit a first pulse having a first wavelength band and a second pulse having a second wavelength band on a substrate on a chuck and output an interface signal, a signal analyzer configured to generate a reference signal based on the second pulse, and generate a heterodyne signal formed by interference between the reference signal and the interface signal, a monochromator configured to separate the heterodyne signal by wavelength, a charge-coupled device configured to measure the heterodyne signal separated by wavelength, and a substrate aligner configured to emit a first laser and a second laser to the substrate, detect and analyze interference fringes between the first laser traveling along a first path and the second laser traveling along a second path, and control a height of the chuck based on a change in the interference fringes, wherein an amplitude of the interface signal and phase information of the interface signal are restored based on the heterodyne signal, and wherein the interface signal corresponds to a type of ions present at an interface and a doping concentration of the ions present at the interface..

### BRIEF DESCRIPTION OF DRAWINGS

The above and other aspects and features of the present disclosure will become more apparent by describing in detail exemplary embodiments thereof with reference to the attached drawings, in which:

FIG. 1 is a diagram illustrating a substrate inspection apparatus according to one or more embodiments;

FIG. 2 is a block diagram illustrating a substrate inspection apparatus according to one or more embodiments;

FIG. 3 is a block diagram illustrating a signal detector of FIG. 2;

FIG. 4 is a block diagram illustrating a signal analyzerof FIG. 2;

FIGS. 5 and 6 are diagrams illustrating a light condition adjustor of FIG. 1;

FIGS. 7 and 8 are diagrams illustrating a process in which an interface signal is generated at an interface of a substrate by a first pulse and a second pulse;

FIG. 9 is a diagram illustrating a substrate aligner of FIG. 1;

FIG. 10 is a diagram illustrating a reference signal generator of FIG. 1;

FIG. 11 is a diagram illustrating a filter of FIG. 1; and

FIG. 12 is a flow chart illustrating a method for inspecting a substrate according to one or more embodiments.

### DETAILED DESCRIPTION

Hereinafter, embodiments will be described in detail with reference to the accompanying drawings. The same reference numerals are used for the same components in the drawings, and the repeated description thereof will not be provided.

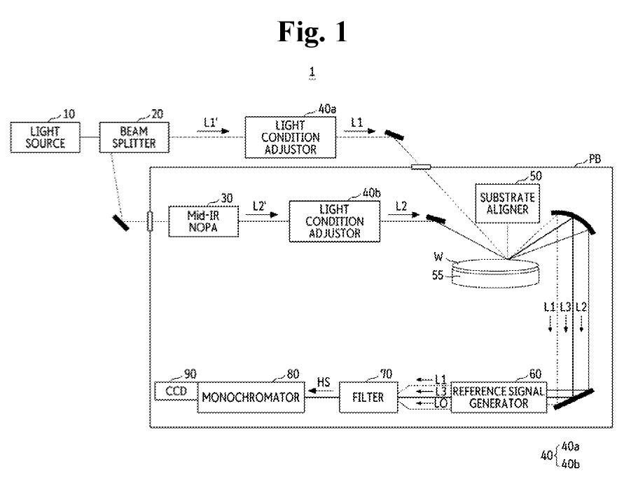

FIG. 1 is a diagram illustrating a substrate inspection apparatus according to one or more embodiments.

Referring to FIG. 1, a substrate inspection apparatus 1 may include a light source 10, a beam splitter 20, a mid-infrared noncolinear optical parametric amplifier (Mid-IR NOPA) 30, a light condition adjustor 40 including a first light condition adjustor 40a and a second light condition adjustor 40b, a substrate aligner 50, a reference signal generator 60, a filter 70, a monochromator 80, and a charge-coupled device (CCD) 90.

The light source 10 may output light. In one or more embodiments, the light source 10 may output a femtosecond pulse. The femtosecond pulse may be a very short laser beam pulse with a duration in femtoseconds (fs).

The light that is output from the light source 10 may be separated by the beam splitter 20 into a first preliminary pulse L1’ and a pulse that is directed to the mid-infrared NOPA 30.

The first preliminary pulse L1’ may be a pulse of a visible light band. A second preliminary pulse L2’ may be converted into a pulse of the mid-infrared band while any pulse separated by the beam splitter 20 passes through the mid-infrared NOPA 30. For example, the mid-infrared band may be 2.5 μm to 10 μm.

Some of the pulse of the mid-infrared band may be transmitted inside a purge box PB filled with nitrogen (N₂) to prevent some regions (e.g., 4 μm to 6 μm) from being absorbed by carbon dioxide (CO₂) and water vapor (H₂O) in the atmosphere. In one or more embodiments, the purge box PB may include the mid-infrared NOPA 30, a light condition adjustor 40b, the substrate aligner 50, the reference signal generator 60, the filter 70, the monochromator 80, and the charge-coupled device 90.

The first preliminary pulse L1’ may be converted into a first pulse L1 while passing through a first light condition adjustor 40a.

The second preliminary pulse L2’ may be converted into a second pulse L2 while passing through a second light condition adjustor 40b.

In one or more embodiments, the first light condition adjustor 40a and the second light condition adjustor 40b may include a configuration for performing at least one of a time delay, adjustment of a polarization state or modulation of an optical signal.

In one or more embodiments, a substrate W may be disposed on an electrostatic chuck 55. The electrostatic chuck 55 is rotatable and may be adjusted in height by the substrate aligner 50.

In one or more embodiments, the substrate aligner 50 may include a laser and an interferometer. The substrate aligner 50 may analyze the interference fringes generated by the plurality of lasers, and control the height of the electrostatic chuck 55 based on the change in the interference fringes. Accordingly, the height of the interface irradiated with a first pulse L1 and a second pulse L2 may be kept constant. An example operation of the substrate aligner 50 will be described below.

In one or more embodiments, the first pulse L1 and the second pulse L2 may be emitted ono the substrate W, and an interface signal L3 may be generated. An example description of the interface signal L3 will be described below.

In one or more embodiments, the reference signal generator 60 may generate a local oscillator signal (LOC) based on the second pulse L2. An example operation of the reference signal generator 60 will be described below.

In one or more embodiments, the filter 70 may filter the interface signal L3 and output a heterodyne signal HS. An example operation of the filter 70 will be described below.

In one or more embodiments, the monochromator 80 may separate the heterodyne signal HS by wavelength. The charge-coupled device (CCD) 90 may measure the intensity of the heterodyne signal HS separated by wavelength. Next, the amplitude and phase information of the interface signal L3 may be restored by the intensity of the heterodyne signal HS. For example, the reference signal LO may be removed from the heterodyne signal HS to restore the amplitude and phase information of the interface signal L3. For example, a reference subtraction or a Fourier transform method may be used to restore the amplitude and phase information of the interface signal L3.

In one or more embodiments, the amplitude and phase information of the interface signal L3 may represent a type of ions present at the interface and a doping concentration of the ions present at the interface.

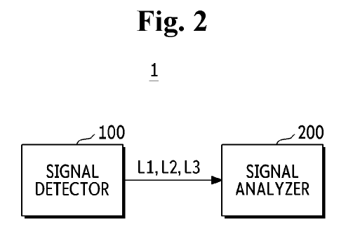

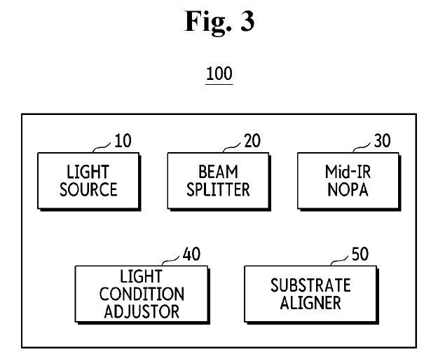

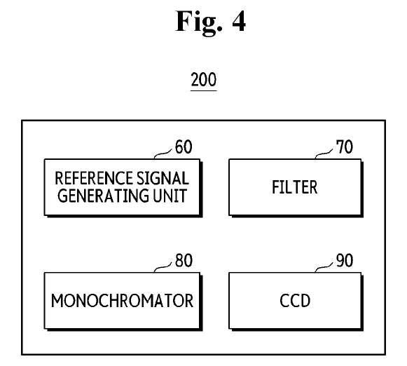

FIG. 2 is a block diagram illustrating a substrate inspection apparatus according to one or more embodiments. FIG. 3 is a block diagram illustrating a signal detector of FIG. 2. FIG. 4 is a block diagram illustrating a signal analyzer of FIG. 2.

Referring to FIGS. 2 - 4, the substrate inspection apparatus 1 may include a signal detector 100 and a signal analyzer 200.

The signal detector 100 may include the light source 10, the beam splitter 20, the mid-infrared NOPA 30, the first and second light condition adjustors 40a and 40b, and the substrate aligner 50.

The signal analyzer 200 may include the reference signal generator 60, the filter 70, the monochromator 80, and the charge-coupled device 90.

In one or more embodiments, the signal detector 100 may emit a substrate with a first pulse L1 and a second pulse L2, and output an interface signal L3.

The first pulse L1, the second pulse L2, and the interface signal L3 generated by the signal detector 100 may be processed by the signal analyzer 200. The amplitude and phase information of the interface signal L3 may be restored based on the heterodyne signal HS processed by the signal analyzer 200, and the type and the doping concentration of ions present at the interface of the substrate may be analyzed.

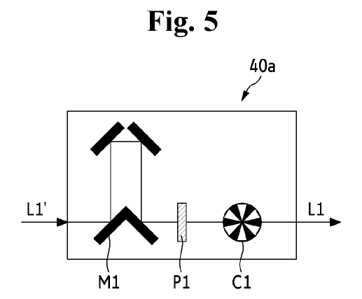

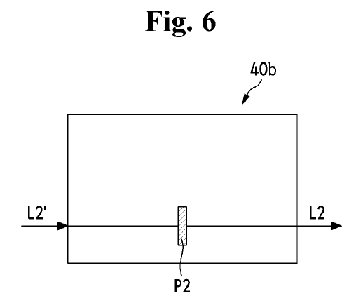

FIGS. 5 and 6 are diagrams illustrating a light condition adjustor of FIG. 1.

Referring to FIG. 5, in one or more embodiments, the first light condition adjustor 40a may include a first optical mirror M1, a first wave plate P1, and a first chopper C1.

In one or more embodiments, the first light condition adjustor 40a may receive the first preliminary pulse L1’, and a time delay may be applied through the first optical mirror M1.

In one or more embodiments, the first wave plate P1 may provide a phase difference between the polarization components of the pulse to adjust the polarization state of the pulse.

In one or more embodiments, the first chopper C1 may be used together with a lock-in amplifier to selectively detect and amplify the pulse. Accordingly, data related to vibration modes that occur at the interface of a sample (e.g., a substrate) may be extracted.

Referring to FIG. 6, in one or more embodiments, the second light condition adjustor 40b may include a second wave plate P2.

In one or more embodiments, the second wave plate P2 may provide a phase difference between the polarization components of the pulse to adjust the polarization state of the pulse.

The first pulse L1 and the second pulse L2 may be optimized through the time delay, polarization adjustment, and signal amplification. Accordingly, the intensity of the interface signal L3 generated by the first pulse L1 and the second pulse L2 may be maximized.

For example, the first preliminary pulse L1’ and the second preliminary pulse L2’ are optimized to generate a sum frequency generation (SFG) effect at the interface of the substrate by the first light condition adjustor 40a and the second light condition adjustor 40b, and may be deformed into the first pulse L1 and the second preliminary pulse L2’.

The configurations of the first light condition adjustor 40a and the second light condition adjustor 40b shown in FIGS. 5 and 6 are merely examples, and embodiments are not limited thereto. For example, the configurations of the first light condition adjustor 40a and the second light condition adjustor 40b may be different from those shown in FIGS. 5 and 6.

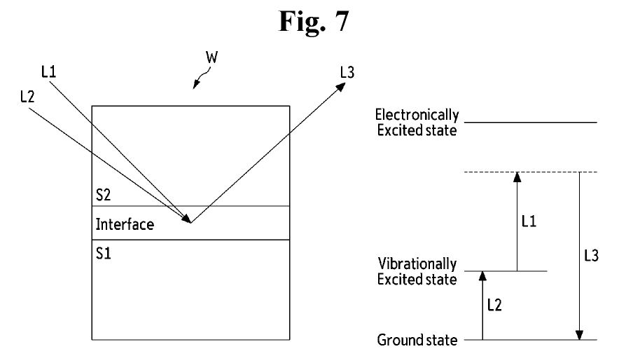

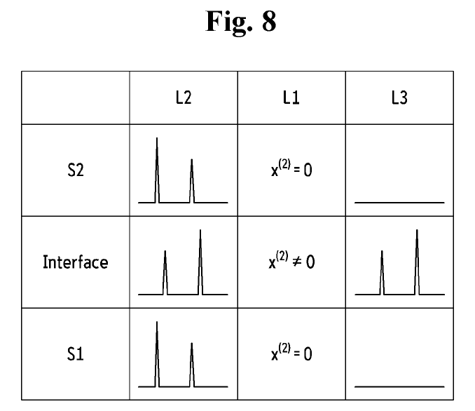

FIGS. 7 and 8 are diagrams illustrating a process in which an interface signal is generated at an interface of a substrate by a first pulse and a second pulse.

Referring to FIGS. 5 - 7, an interface inside the substrate W may be irradiated with the first pulse L1 generated by the first light condition adjustor 40a and the second pulse L2 generated by the second light condition adjustor 40b.

In one or more embodiments, the substrate W may include a first region S1 and a second region S2. An interface may exist between the first region S1 and the second region S2.

For example, the first region S1 may include silicon (Si). The second region S2 may include silicon dioxide (SiO₂).

In one or more embodiments, a plurality of ions may exist at the interface between the first region S1 and the second region S2. For example, the interface may include hydrogen ions or nitrogen ions, and the like.

Referring to FIGS. 7 and 8, the substrate W may be irradiated with the second pulse L2. For example, the interface of the substrate W on which the concentration of the ions is to be measured may be irradiated with the second pulse L2. The second pulse L2 may include a frequency spectrum of the ions at which the concentration is to be measured. The second pulse L2 may activate the vibration modes of the first region S1, the second region S2, and the interface of the substrate W. The vibration modes caused by the second pulse L2 shown in FIG. 8 are merely exemplary, and embodiments may include forms of vibration modes of the first region S1, the second region S2, and the interface of different forms.

In one or more embodiments, the substrate W may be irradiated with the first pulse L1. For example, the interface of the substrate W on which the concentration of ions is to be measured may be irradiated with the first pulse L1.

Because there is no inversion symmetry at the interface, a second harmonic generation (SHG) conversion efficiency coefficient (χ(2)) is not zero. For example, the SHG effect may occur.

Therefore, an interaction between the first pulse L1 and the second pulse L2 may occur at the interface. In addition, an interface signal L3 may be generated by the interaction between the first pulse L1 and the second pulse L2. A frequency ω3 of the interface signal L3 may be the sum of a frequency ω1 of the first pulse L1 and a frequency ω2 of the second pulse L2.

In one or more embodiments, the interface signal L3 may include information such as the vibration mode and doping concentration generated at the interface of the substrate W.

In this way, the type of ions present at the interface, the doping concentration and the like may be checked by the signal generated by irradiating the interface of the substrate W with a pulse. For example, a substrate inspection apparatus that may check the doping profile, electrical characteristics and resistance characteristics of the channel of the substrate W in a non-contact and non-destructive manner may be provided.

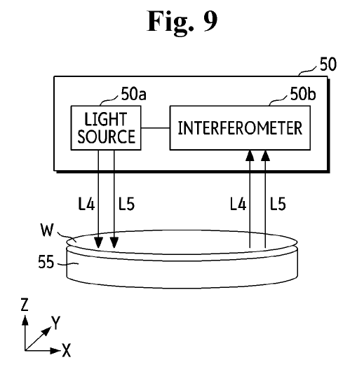

FIG. 9 is a diagram illustrating a substrate aligner of FIG. 1.

Referring to FIG. 9, the substrate aligner 50 may include an alignment light source 50a and an interferometer 50b.

In one or more embodiments, the alignment light source 50a may emit a first laser L4 and a second laser L5 generated by separating one laser to the substrate W. The first laser L4 and the second laser L5 may be provided to the interferometer 50b through different paths from each other. For example, the alignment light source 50a may be a He-Ne laser. However, this is merely an example, and embodiments are not limited thereto.

In one or more embodiments, interference fringes may be generated by a first laser L4 and a second laser L5 provided to the interferometer 50b through different paths from each other. The interferometer 50b may sense a change in the position (e.g., height) of the substrate W in a third direction Z by a change in the interference fringes. As another example, the interferometer 50b may sense a slope in a first direction X and/or a second direction Y by a change in the interference fringes. Accordingly, the height and slope of the substrate W are inspected in real time while inspecting the interface of the substrate W, and the height of the interface of the substrate W may be kept constant.

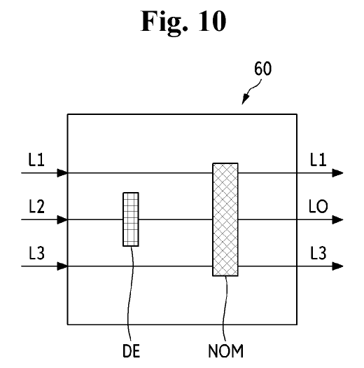

FIG. 10 is a diagram illustrating a reference signal generator of FIG. 1.

Referring to FIG. 10, the reference signal generator 60 may include an optical delay element DE and a nonlinear optical medium NOM.

For example, the optical delay element DE may include calcium fluoride (CaF₂). The nonlinear optical medium NOM may include silicon dioxide (SiO₂, Quartz). However, embodiments are not limited thereto.

In one or more embodiments, the reference signal generator 60 may be provided with the first pulse L1, the second pulse L2, and the interface signal L3.

The first pulse L1 and the interface signal L3 pass through the nonlinear optical medium NOM and may be output to the outside.

The optical delay element DE may apply a time delay to the second pulse L2. Further, the time-delayed second pulse L2 is incident on the nonlinear optical medium NOM, and a self-sum frequency generation (Self-SFG) may occur. A reference signal LO may be generated, accordingly. For example, the reference signal LO may be a local oscillator signal (LO). The reference signal LO interferes with the interface signal L3 to provide a phase comparison reference, making it possible to restore the amplitude and phase information of the interface signal L3.

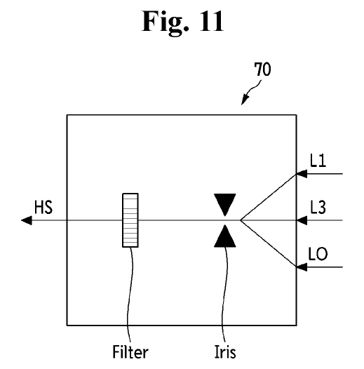

FIG. 11 is a diagram illustrating a filter of FIG. 1.

Referring to FIG. 11, the filter 70 may include an iris and an optical filter. The iris may be, for example, an iris.

In one or more embodiments, the filter 70 may block the first pulse L1. The interface signal L3 and the reference signal LO may pass through the filter 70, and the interface signal L3 and the reference signal LO may interfere with each other to generate a heterodyne signal HS.

Referring to FIG. 1, the heterodyne signal HS that has passed through the filter 70 may be separated by wavelength by the monochromator 80. Further, the heterodyne signal HS separated by wavelength may be measured by the charge-coupled device 90.

The amplitude and phase information of the interface signal L3 may be restored based on the measurement value obtained by measuring the heterodyne signal HS. For example, the amplitude and phase information of the interface signal L3 may be restored by removing the reference signal LO from the heterodyne signal HS. For example, a reference subtraction or a Fourier transform method may be used to restore the amplitude and phase information of the interface signal L3.

In one or more embodiments, the amplitude and phase information of the interface signal L3 may represent the type and the doping concentration of ions present at the interface.

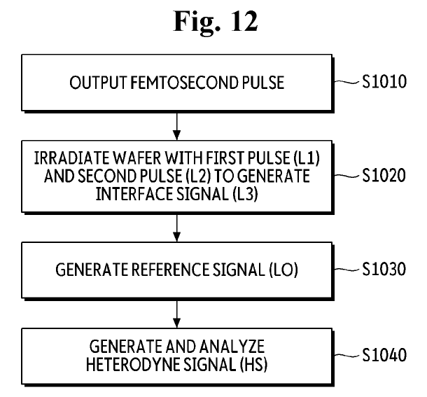

FIG. 12 is a flow chart illustrating a method for inspecting a substrate according to one or more embodiments.

Referring to FIGS. 1 and 12, a femtosecond pulse is output (S1010).

Referring to FIGS. 7 and 12, a wafer is irradiated with the first pulse L1 and the second pulse L2 generated by the femtosecond pulse, and the interface signal L3 is generated by the first pulse L1 and the second pulse L2 (S1020).

Since the process of generating the interface signal L3 by the first pulse L1 and the second pulse L2 has been described above through FIGS. 7 and 8, the description thereof will not be provided.

Referring to FIGS. 10 and 12, the reference signal LO is generated based on the second pulse L2 (S1030).

Since the process of generating the reference signal LO based on the second pulse L2 has been described above through FIG. 10, the description thereof will not be provided.

Referring to FIGS. 1, 11 and 12, the heterodyne signal HS may be generated by the reference signal LO and the interface signal L3. The heterodyne signal HS is then analyzed to restore the amplitude and phase information of the interface signal L3, and the type and the doping concentration of ions present at the interface may be checked by the amplitude and phase information of the interface signal L3 (S1040).

Since the process of generating and analyzing the heterodyne signal HS is described above through FIGS. 1 and 11, the description thereof will not be provided.

At least one of the components, elements, modules or units (collectively "components" in this paragraph) represented by a block or an equivalent indication in the drawings may be implemented or embodied by analog and/or digital circuits including one or more of a logic gate, an integrated circuit, a microprocessor, a microcontroller, a memory circuit, a passive electronic component, an active electronic component, an optical component, and the like. Alternatively or additionally, these components may be implemented or embodied by software including one or more instructions stored in an internal or external storage medium that is readable by at least one processor. For example, the at least one processor may invoke at least one of the one or more instructions stored in the storage medium, and execute it, with or without using one or more other components under the control of the at least one processor. This allows the at least one processor to perform at least one function or operation described above as being performed by each of the components according to the at least one instruction invoked. Here, the at least one processor may include a central processing unit (CPU), a graphic processing unit (GPU), another type of microprocessor, not being limited thereto.

While embodiments have been described with reference to the figures, it will be understood by those of ordinary skill in the art that various changes in form and details may be made therein without departing from the spirit and scope as defined by the following claims and their equivalents.

What is claimed is:

1. A substrate inspection apparatus comprising:
a signal detector configured to emit a first pulse having a first wavelength band and a second pulse having a second wavelength band to a substrate and output an interface signal; and
a signal analyzer configured to generate a reference signal based on the second pulse, and generate a heterodyne signal formed by interference between the reference signal and the interface signal,
wherein an amplitude of the interface signal and phase information of the interface signal are restored based on the heterodyne signal.

2. The substrate inspection apparatus of claim 1, further comprising:
a substrate aligner configured to emit a first laser and a second laser to the substrate, and detect and analyze interference fringes between the first laser traveling along a first path and the second laser traveling along a second path.

3. The substrate inspection apparatus of claim 2, wherein the substrate is on a chuck, and
wherein the substrate aligner is further configured to control a height of the chuck based on a change in the interference fringes.

4. The substrate inspection apparatus of claim 1, wherein the reference signal is configured to apply a first time delay to the second pulse, and
wherein the first time-delayed second pulse is generated by self-sum frequency generation (Self-SFG).

5. The substrate inspection apparatus of claim 4, further comprising:
a monochromator configured to separate the heterodyne signal by wavelength; and
a charge-coupled device (CCD) configured to measure the heterodyne signal separated by wavelength.

6. The substrate inspection apparatus of claim 1, wherein the first wavelength band is a mid-infrared (Mid IR) region, and
wherein the second wavelength band is a visible light region.

7. The substrate inspection apparatus of claim 6, wherein the substrate comprises an interface between a first region and a second region,
wherein the second pulse is configured to activate a vibration mode of the first region, a vibration mode of the second region, and a vibration mode of the interface, and
wherein the interface signal is generated by interaction of the first pulse with the vibration mode of the interface.

8. The substrate inspection apparatus of claim 7, wherein the first region comprises silicon (Si), and
wherein the second region comprises silicon oxide (SiO₂8).

9. The substrate inspection apparatus of claim 7, wherein a frequency of the interface signal is a sum of the frequency of the first pulse and the frequency of the second pulse.

10. The substrate inspection apparatus of claim 7, wherein the interface signal corresponds to a type of ions present at the interface and a doping concentration of the ions present at the interface.

11. A method for inspecting a substrate comprising:
outputting a femtosecond pulse by a light source;
separating the femtosecond pulse into a first pulse having a first wavelength band and a second pulse having a second wavelength band by a beam splitter;
emitting the first pulse and the second pulse to a wafer and outputting an interface signal;
generating a reference signal based on the second pulse;
generating a heterodyne signal formed by interference between the reference signal and the interface signal; and
restoring an amplitude and phase information of the interface signal based on the heterodyne signal.

12. The method for inspecting the substrate of claim 11, further comprising:
emitting a first laser and a second laser on the substrate;
detecting and analyzing interference fringes between the first laser traveling along a first path and the second laser traveling along a second path; and
controlling a height of a chuck on which the substrate is disposed, based on a change in the interference fringes.

13. The method for inspecting the substrate of claim 11, wherein the generating of the reference signal comprises:
applying a first time delay to the second pulse, and
generating self-sum frequency generation (self-SFG) of the first time-delayed second pulse.

14. The method for inspecting the substrate of claim 13, further comprising:
separating the heterodyne signal by wavelength by a monochromator; and
measuring the heterodyne signal separated by wavelength by a charge-coupled device (CCD).

15. The method for inspecting the substrate of claim 11, wherein the first wavelength band is a mid-infrared (Mid IR) region, and
wherein the second wavelength band is a visible light region.

16. The method for inspecting the substrate of claim 15, wherein the substrate comprises an interface between a first region and a second region,
wherein the second pulse is configured to activate a vibration mode of the first region, a vibration mode of the second region, and a vibration mode of the interface, and
wherein the interface signal is generated by interaction of the first pulse with the vibration mode of the interface.

17. The method for inspecting the substrate of claim 16, wherein the first region comprises silicon (Si), and
wherein the second region comprises silicon oxide (SiO₂17).

18. The method for inspecting the substrate of claim 16, wherein a frequency of the interface signal is a sum of the frequency of the first pulse and the frequency of the second pulse.

19. The method for inspecting the substrate of claim 16, wherein the interface signal corresponds to a type of ions present at the interface and a doping concentration of the ions present at the interface.

20. A substrate inspection apparatus comprising:
a signal detector configured to emit a first pulse having a first wavelength band and a second pulse having a second wavelength band on a substrate on a chuck and output an interface signal;
a signal analyzer configured to generate a reference signal based on the second pulse, and generate a heterodyne signal formed by interference between the reference signal and the interface signal;
a monochromator configured to separate the heterodyne signal by wavelength;
a charge-coupled device configured to measure the heterodyne signal separated by wavelength; and
a substrate aligner configured to emit a first laser and a second laser to the substrate, detect and analyze interference fringes between the first laser traveling along a first path and the second laser traveling along a second path, and control a height of the chuck based on a change in the interference fringes,
wherein an amplitude of the interface signal and phase information of the interface signal are restored based on the heterodyne signal, and
wherein the interface signal corresponds to a type of ions present at an interface and a doping concentration of the ions present at the interface.
